(19) United States
(12) Patent Application Publication
(10) Pub. No.: US 2014/0254067 A1
(43) Pub. Date: Sep. 11, 2014

(54) TANTALUM CAPACITOR

(71) Applicant: Samsung Electro-Mechanics Co., Ltd., Gyeonggi-do (KR)

(72) Inventors: Hee Dong Myung, Gyeonggi-do (KR); Jeong Oh Hong, Gyeonggi-do (KR); Hee Sung Choi, Gyeonggi-do (KR); Kyoung Hwan Kim, Gyeonggi-do (KR)

(73) Assignee: Samsung Electro-Mechanics Co., Ltd., Gyeonggi-do (KR)

(21) Appl. No.: 13/957,396

(22) Filed: Aug. 1, 2013

(30) Foreign Application Priority Data
Mar. 8, 2013 (KR) 10-2013-0024943

(51) Int. Cl. H01G 9/012; H01G 9/032

(52) U.S. Cl. CPC H01G 9/012; H01G 9/032
USPC 361/525

(57) ABSTRACT

Disclosed herein is a tantalum capacitor capable of improving equivalent series resistance (ESR) characteristic by increasing the bond between a tantalum wire and a tantalum powder. The tantalum capacitor according to the present invention includes: a tantalum wire; a tantalum powder having embedded a front end of the tantalum wire and then being sintered; and a rough part formed on a surface of the tantalum wire so as to strengthen a bond between the tantalum wire and the tantalum powder.

### CROSS REFERENCE(S) TO RELATED APPLICATIONS

This application claims the benefit under 35 U.S.C. Section 119 of Korean Patent Application Serial No. 10-2013-0024943, entitled “Tantalum Capacitor” filed on Mar. 8, 2013, which is hereby incorporated by reference in its entirety into this application.

### BACKGROUND OF THE INVENTION

1. Technical Field

The present invention relates to a tantalum capacitor, and more particularly, to a tantalum capacitor capable of improving an equivalent series resistance (ESR) characteristic by increasing the bonding between a tantalum wire and a tantalum powder.

2. Description of the Related Art

Tantalum capacitors have been widely used in communication applications, computers, automobiles, home appliances, and aircrafts, for example. Tantalum electrolytic capacitors use a tantalum powder as an anode and a tantalum wire as an anode lead, and have advantages of smaller volume, larger electric capacitance, and high-degree of chip type, good reliability and long lifetime. Accordingly, the tantalum electrolytic capacitors are normally operable under extreme conditions where many other capacitors (such as ceramic, aluminum, and sheet capacitors) are not.

The tantalum wire used as anode lead of a tantalum capacitor is required to have mechanical and electrical properties that meet the strict requirements in capacitors, and also to have high chemical purity, good surface finish and accurate dimensions.

For instance, regarding surface finish of the surface of a tantalum wire, it is particularly required that apparent shortcomings such as grooves, notched portions, and polishing grooves are not supposed to be found when observing the surface with a microscope of 60 magnification or more. Regarding electrical properties, it is particularly required to have as less leakage current as possible.

As the electronic technology develops, requirements for tantalum capacitors tend to increase. The tantalum capacitors are gradually developed to have a specific capacity that tantalum powder is increasingly used, to be sized down, to be chip-typed, and to have high capacitance.

The above limits the sintering temperature of anode pellets of tantalum capacitors. If the sintering temperature is too high, porous property of tantalum powder is greatly decreased, thereby causing the specific capacity to be reduced.

However, it is a disadvantage that when a circular anode lead in the related art is used in a low sintering tantalum capacitor, an anode lead obtained with the circular tantalum wire has small contact area with tantalum anode pellets due to its relatively small surface area, thereby causing low contact strength and excessive leakage current of the tantalum capacitor. Furthermore, this results in shedding of the tantalum wire from the anode pellet and thus failure of the tantalum capacitor.

As tantalum capacitors become smaller, the low pullout strength of the lead wire of the tantalum capacitors has a vital influence on electrical property and reliability of the tantalum capacitor.

### RELATED ART DOCUMENT

### Patent Document

(Patent Document 1) Japanese Patent Laid-open Publication No. 2011-243898

### SUMMARY OF THE INVENTION

An object of the present invention is to provide a tantalum capacitor which improves electrical properties and reliability by strengthening bond between a tantalum wire and tantalum powder.

According to an exemplary embodiment of the present invention, there is provided a tantalum capacitor including a tantalum wire; a tantalum powder having embedded a front end of the tantalum wire and then being sintered; and a rough part formed on a surface of the tantalum wire so as to strengthen a bond between the tantalum wire and the tantalum powder.

The rough part may be formed either by performing a blast process on the surface of the tantalum wire or by performing a knurling process on the surface of the tantalum wire.

The tantalum wire may have the cross-sectional area from 0.007 to 0.0636 mm².

The tantalum powder may be composed of grains having smaller size than a diameter of a hole of the rough part.

### BRIEF DESCRIPTION OF THE DRAWINGS

FIG. 1 is a view illustrating a process of roughening the surface of a tantalum wire according to an exemplary embodiment of the present invention;

FIG. 2 is a view illustrating a wire of a tantalum capacitor bonded with a powder according to an exemplary embodiment of the present invention;

FIG. 3 is a cross-sectional view of a bonded part of FIG. 2; and

FIG. 4 is a set of views showing an ESR characteristic of a tantalum wire according an exemplary embodiment of the present invention.

### DESCRIPTION OF THE PREFERRED EMBODIMENTS

Hereinafter, exemplary embodiments of the present invention will be described in detail with reference to the accompanying drawings.

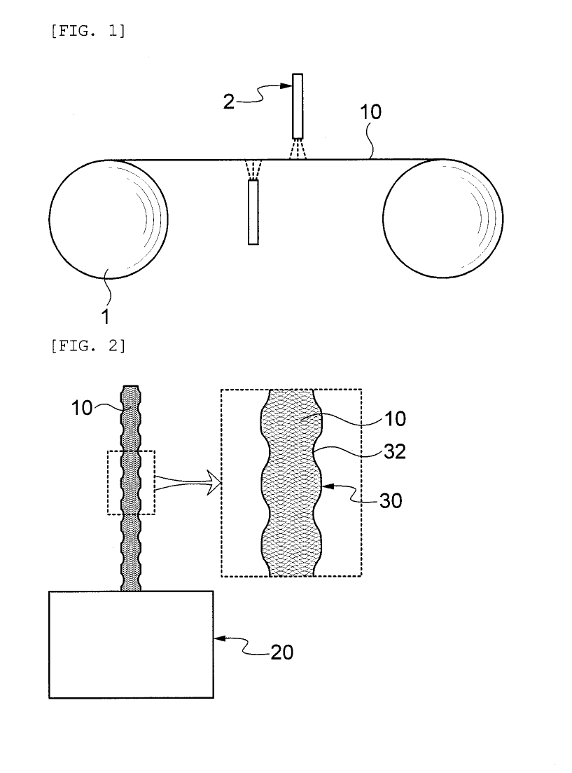

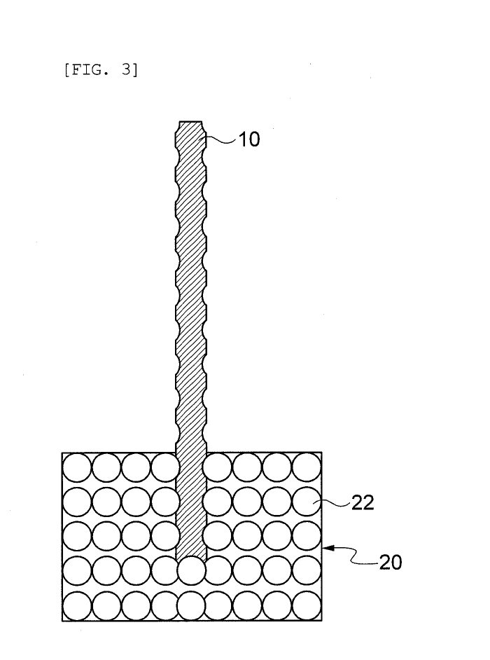

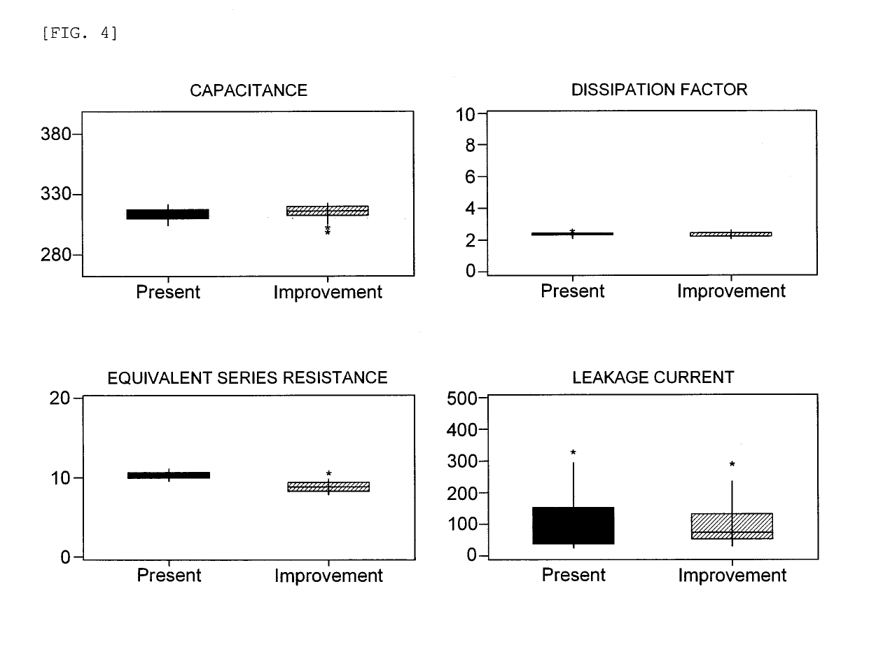

FIG. 1 is a view illustrating a process of roughening the surface of a tantalum wire according to an exemplary embodiment of the present invention; FIG. 2 is a view illustrating a wire of a tantalum capacitor bonded with a powder according to an exemplary embodiment of the present invention; FIG. 3 is a cross-sectional view of a bonded part of FIG. 2; and FIG. 4 is a set of views showing an ESR characteristic of a tantalum wire according an exemplary embodiment of the present invention.

As shown in the drawings, a tantalum capacitor (not shown in the drawings) according to an exemplary embodiment of the present invention includes a tantalum wire 10, a tantalum powder 20 integrated with the tantalum wire 10 having its front end embedded, and a rough part 30 formed by roughening the surface of the tantalum wire 10.

The tantalum wire 10 is on a pair of spools 1 spaced apart, and is wound on and unwound from the spools 1 as they rotate.

The tantalum wire 10 may have either a cylinder shape or a quadrangle shape.

Although the tantalum wire 10 may be either a cylinder shape or quadrangle shape, a cylinder-shaped tantalum wire 10 will be described in the exemplary embodiment since the present invention is irrelevant to the process of fabricating the tantalum wire 10 itself.

As the spools 1 rotate, the tantalum wire 10 moves from one spool to the other, between which roughening units 2 are disposed for roughening the surface of the tantalum wire 10.

The roughening units 2 may be blast devices to strike the surface of the tantalum wire 10 or knurling devices to form certain positive and negative angles to the surface of the tantalum wire.

If the roughening units 2 are of the blast devices, the tantalum wire 10 is subjected to a blast process in which minute grains are sprayed on the surface thereby to obtain high roughness.

That is, the blast process forms roughness of certain depth on the surface of the tantalum wire 10 by continuously spraying minute grains on the surface, as in a sand blast process.

If the roughening units 2 are of the knurling devices, positive and negative angles are formed on the surface of the tantalum wire 10 by deforming the surface of the tantalum wire 10 with pressure. Accordingly, roughness of certain depth is formed on the surface of the tantalum wire, as in the blast process.

Here, the tantalum wire 10 may have the cross-sectional area of 0.007 to 0.0636 mm². Such diameter ranges are designed according to the standard of a capacitor when the tantalum wire 10 is provided in the capacitor.

After the rough part 30 is formed on the surface of the tantalum wire 10 as above, the tantalum wire 10 is separated from the spools 1, and cut according to the standard of the capacitor.

The cut tantalum wire 10 is subjected to cleaning and drying, and the front end of the tantalum wire 10 is embedded into the tantalum powder 20 during sintering, such that tantalum wire 10 is integrated with the tantalum power 20.

That is, the tantalum powder 20 is put into a shaping mold, the front end of the tantalum wire 10 is inserted therein, and then certain pressure is applied to the mold, thereby obtaining a certain shape. Once the shape is obtained, it is subjected to sintering and certain amount of powder grains (pellets) 22 are compressed.

After sintering of the tantalum powder 20 is completed, the tantalum wire 10 and the tantalum powder 20 have strong bonding to each other.

When the tantalum wire 10 according to the exemplary embodiment of the present invention is subjected to a process for roughening the surface such as a blast or knurling process, holes 32 are formed on the surface of tantalum wire 10 which have a certain depth and are generally circular or polygonal.

If the tantalum wire 10 is subjected to the blast process, the size of the grains used in the blast process is selected so that the diameter of the holes 32 is larger than that of the grains 22 of the tantalum powder 20.

In the knurling process, on the contrary, since the size of the holes 32 formed on the surface of the tantalum capacitor wire 10 is inherently larger than the size of the grains 22 of the tantalum powder 20, no process for selecting is required.

Rough parts 30 formed on the surface of the tantalum capacitor wire 10 allows grains 22 of the tantalum powder to be sufficiently filled in the holes 32, and then the tantalum capacitor wire 10 is subjected to press process by a mold and sintering process, such that strong banding between is kept between the tantalum capacitor wire 10 and the tantalum powder 20.

Moreover, if the bonding between the tantalum wire 10 and the tantalum powder 20 is stably kept, then equivalent series resistance ESR of a product is very efficiently improved.

Table 1 below indicates changes in characteristics of a tantalum capacitor in which a tantalum wire 10 having a rough surface has been mounted and an ESR has been measured.

TABLE 1

| Comparison | Cap_μF | DF_% | ESR_mΩ | LC_μA |
|---|---|---|---|---|
| Present | 312.7 | 2.3 | 10.4 | 100.9 |
| Improvement | 315.2 | 2.3 | 8.9 | 105.7 |
| Gap | ▴ 2.5 | — | ▾ 1.4 | ▴ 4.7 |

The term “Cap” denotes capacitance, the term “DF” denotes dissipation factor, the term “ESR” denotes equivalent series resistance, and the term “LC” denotes leakage current.

As can be seen from Table 1 above, capacitance has been increased by about 2.5 μf, and no change has been found in a dissipation factor.

In addition, it can be seen that equivalent series resistance has been reduced by 1.4 mΩ, and leakage current is increased by 4.5 μA.

Although there has been a minor increase in leakage current, it is trivial; and, therefore, the ESR is reduced and capacitance is increased as required for electronic devices.

Accordingly, even in a low ESR polymer tantalum capacitor difficult to implement the ESR, ESR level is significantly lowered, such that marketability may be improved.

As stated above, in the tantalum capacitor according to the present invention, bond strength between a tantalum wire and tantalum powder is strengthened, thus, the pullout strength is increased, such that electrical properties and reliability of the tantalum capacitor can be improved.

Thus far, although the tantalum capacitor has been described according to the exemplary embodiment of the present invention, the present invention is not limited thereto, but may be variously modified and altered by those skilled in the art.

What is claimed is:

1. A tantalum capacitor, comprising:
a tantalum wire;
a tantalum powder having embedded a front end of the tantalum wire and then being sintered; and
a rough part formed on a surface of the tantalum wire so as to strengthen a bond between the tantalum wire and the tantalum powder.

2. The tantalum capacitor according to claim 1, wherein the rough part is formed by performing a blast process on the surface of the tantalum wire.

3. The tantalum capacitor according to claim 1, wherein the rough part is formed by performing a knurling process on the surface of the tantalum wire.

4. The tantalum capacitor according to claim 1, wherein the tantalum wire has a cross-sectional area from 0.007 to 0.0636 mm².

5. The tantalum capacitor according to claim 1, wherein the tantalum powder includes grains having a smaller size than a diameter of a hole of the rough part.
